(19) United States
(12) Patent Application Publication
(10) Pub. No.: US 2020/0121433 A1
(43) Pub. Date: Apr. 23, 2020

(54) Dental Device

(71) Applicant: Colgate-Palmolive Company, New York, NY (US)

(72) Inventors: Takahide OKAI, Highland Park, NJ (US); John GATZEMEYER, Hillsborough, NJ (US)

(73) Assignee: Colgate-Palmolive Company, New York, NY (US)

(21) Appl. No.: 16/162,737

(22) Filed: Oct. 17, 2018

(51) Int. Cl. A61C 19/06

(52) U.S. Cl. CPC A61C 19/066

(57) ABSTRACT

A dental tray may include: a facial wall conforming to a facial dental arch of a wearer and having first and second ends; a first clip element coupled to and extending from the first end and configured to apply a first lateral pressure on a wearer's first tooth when it is inserted into the first clip; and a second clip element coupled to and extending from the second end and configured to apply a second lateral pressure on a wearer's second tooth when it is inserted into the second clip; wherein the front wall is formed of a first material having a first hardness, and each clip element is formed of a second material having a second hardness, the second hardness being greater than the first hardness.

### BACKGROUND

As teeth whitening has gained in popularity, so has the use of at home methods to whiten teeth. A common whitening method involves the use of a dental tray that is custom-fitted to an individual's teeth so that the dental tray is comfortable to wear, making the at home teeth whitening process an even more desirable option. The downside of some types of custom-fitted dental trays is that they can be costly for the consumer. Other types of custom-fitted dental trays require the individual to soften the material of the dental tray by boiling it in water, and then biting on the dental tray to leave an impression of the individual's teeth. These latter types of custom-fitted dental trays can be difficult for some people to use.

While dental trays that are not custom-fitted can be less expensive and can provide less hassle to the user prior to the actual whitening process, they are not without their difficulties to use. Non-customized dental trays do not typically fit all individuals, they can be less comfortable, and they often do no stay positioned on the teeth quite as well as custom-fitted dental trays. A need therefore exists for dental devices which improve upon existing non-customized dental trays.

### BRIEF SUMMARY

Exemplary embodiments according to the present disclosure are directed to non-customized dental devices, which in certain embodiments are in the form of dental trays, and which advantageously utilize materials of different hardness to provide the wearer with ease of use and comfort during use, such as during teeth whitening processes. Softer materials may be advantageously used to reduce and/or eliminate irritation to the gums and to provide form-fitting levels of comfort. Harder materials may be strategically used to maintain the position of the dental device in the mouth and to enable the dental device to have a wider range of fit, so that a single configuration can fit a greater number of users. The non-customized dental devices may have a variety of uses, including for the application of gels or other compounds to perform teeth whitening, treat teeth sensitivity, and apply fluoride treatments.

In one aspect, the invention can be a dental device including: a facial wall configured to conform to a facial dental arch of a wearer, the facial wall having a first end and a second end; a first clip element coupled to and extending from the first end, the first clip element configured to apply a first lateral pressure on a first tooth of the wearer when the first tooth is inserted into the first clip; and a second clip element coupled to and extending from the second end, the second clip element configured to apply a second lateral pressure on a second tooth of the wearer when the second tooth is inserted into the second clip; wherein the front wall is formed of a first material having a first hardness, and each clip element is formed of a second material having a second hardness, the second hardness being greater than the first hardness.

In another aspect, the invention can be a dental device including: an arcuate tray member configured to conform to a dental arch of a wearer, the arcuate tray member having a first lateral side and a second lateral side; a first clip element incorporated into the first lateral side, the first clip element configured to apply a first lateral pressure on a first tooth of the wearer when the first tooth is inserted into the first clip; a second clip element incorporated into the second lateral side, the second clip element configured to apply a second lateral pressure on a second tooth of the wearer when the second tooth is inserted into the second clip; wherein the arcuate tray member is at least partially formed of a first material having a first hardness, and each clip element is formed of a second material having a second hardness, the second hardness being greater than the first hardness.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 illustrates a perspective view of a dental device in accordance with a first embodiment of the present invention.

FIG. 2 illustrates a rear elevational view of the dental device of FIG. 1.

FIG. 3 illustrates a top plan view of the dental device of FIG. 1.

FIG. 4 illustrates a cross-sectional view along the line VI-VI of the dental device of FIG. 1.

FIGS. 5A-B illustrate a tooth being inserted into a clip element incorporated into a dental device.

FIG. 6 illustrates a perspective view of a dental device in accordance with a second embodiment of the present invention.

FIG. 7 illustrates a rear elevational view of the dental device of FIG. 6.

FIG. 8 illustrates a perspective view of a dental device in accordance with a third embodiment of the present invention.

FIG. 9 illustrates a rear elevational view of the dental device of FIG. 8.

FIG. 10 illustrates a perspective view of a dental device in accordance with a fourth embodiment of the present invention.

FIG. 11 illustrates a rear elevational view of the dental device of FIG. 10.

FIG. 12 illustrates a perspective view of a dental device in accordance with a fifth embodiment of the present invention.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

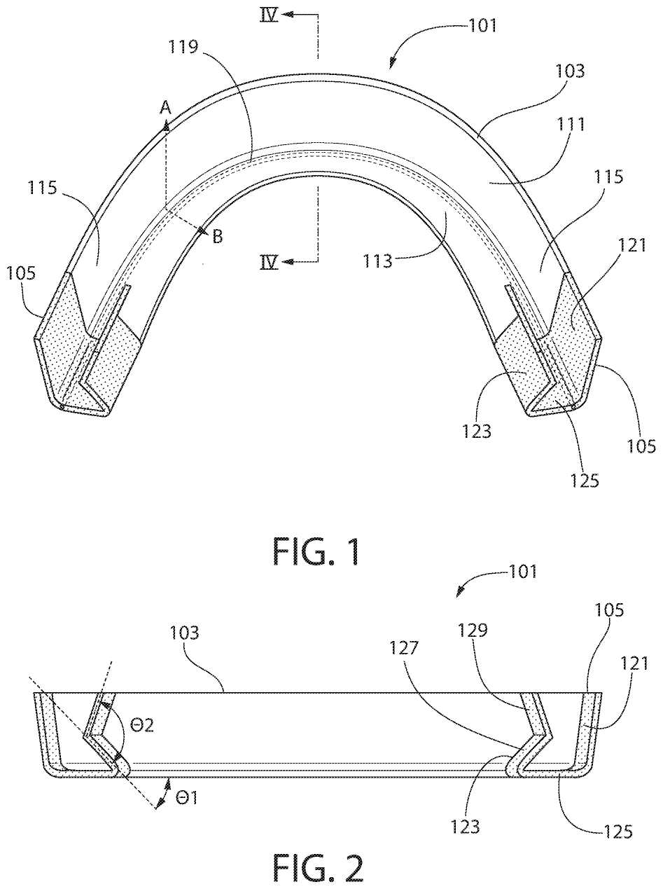

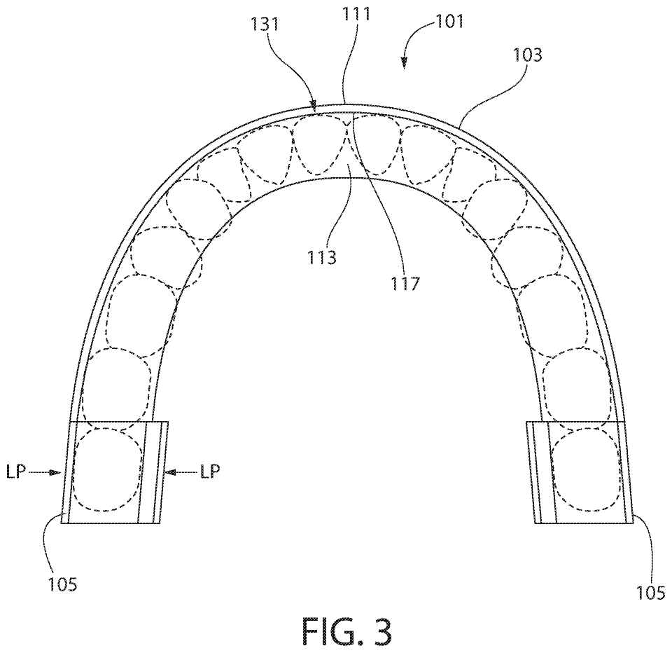

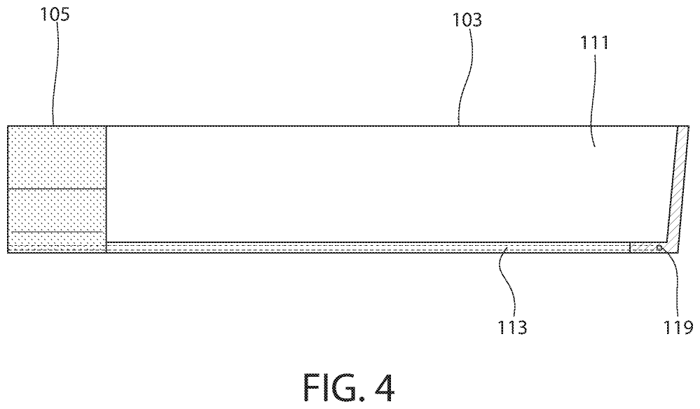

Referring to, FIGS. 1-4 a dental device 101 is illustrated in accordance with an embodiment of the present invention. The dental device 101 includes an L-shaped arcuate tray member 103 with clip elements 105 extending from the ends 115 thereof In certain embodiments, the walls of the clip elements 105 have the same thickness as the walls of the L-shaped arcuate tray member 103 from which they extend. The arcuate tray member 103 includes a facial wall 111 and a biting surface wall 113. In the embodiment shown, throughout at least a substantial part of the arc, the facial wall 111 is substantially extends in alignment with the axis A, and the biting surface wall 113 is substantially formed in the plane of the axis B. As can be seen in FIG. 3, the facial wall 111 is formed to conform to the facial dental arch (upper or lower) of the teeth 131 of a wearer when the dental device 101 is worn, with the interior surface 117 of the facial wall 111 being positioned adjacent the teeth 131 and the biting surface wall 113 being positioned adjacent the biting surface of the teeth 131. In certain embodiments, the biting surface wall 113 is substantially located within a plane. In certain other embodiments, the biting surface wall 113 may be non-planar.

The dental device 101 also includes a spring wire 119 embedded within the biting surface wall 113. The spring wire 119 can help preserve the overall shape of the arcuate tray member 103 when the dental device 101 is being worn. To do this, the spring wire 119 acts as a resilient spring element to both allow the arc of the arcuate tray member 103 to expand and contract and to also return the arc of the arcuate tray member 103 to its original shape when no longer being worn. Expansion or contraction of the arcuate tray member 103 can better enable the dental device 101, as a non-customized device, to better fit the dental arch of a wider group of users. In certain embodiments, the spring wire 119 may be made from stainless steel. In certain embodiments, the spring wire 119 may be located below the biting surface wall 113, with the ends of the spring wire 119 extending into, or being held in place by, appropriate receiving features of each of the clip elements 105. Although the embodiment of the dental device 101 shown in FIG. 1 is shown with the spring wire 119, the dental device 101 may also be made without the spring wire 119.

In the embodiment of the dental device 101 shown in FIG. 1, the arcuate tray member 103 is formed from a first material having a first hardness, and the clip elements 105 are formed from a second material having a second hardness, with the second hardness being greater than the first hardness. In certain embodiments, the arcuate tray member 103 may be formed from a suitable elastomeric material, and the clip elements 105 may be formed from a suitable hard plastic material. In certain other embodiments, the clip elements 105 may be partially or wholly covered in a layer of the first material in order to reduce the impact of the harder second material on the teeth and gums of the user.

Suitable elastomeric materials for formation of the arcuate tray member 103 may include a thermoplastic polyurethane (TPU), a thermoplastic elastomer (TPE), or styrene-ethylene/butylene-styrene (SEBS). Suitable plastics for formation of the clip elements 105 may include polyethylene, polyethylene terephthalate, polypropylene (PP), polyamide, polyester, cellulosics, SAN, acrylic, ABS, BR or any other type of hard plastic that is suitable for oral use. As used herein, the term “plastic” may include a blend of different plastics or a copolymer. Other materials could be used for one or both of the arcuate tray member 103 and the clip elements 105. In certain embodiments, the elastomeric material may have a hardness durometer in a range of A11 to A15 Shore hardness. Of course, materials outside this hardness range could be used. In certain embodiments, the hard plastic material may have a hardness durometer in a range of about A30 or greater Shore hardness.

In certain embodiments, the elastomeric material and the hard plastic material are selected so as to be chemically compatible with one another, such that a chemical bond is formed between the elastomeric material and the hard plastic material during a co-injection molding process. In one such specific embodiment, the elastomeric material can be a TPU while the hard plastic material can be PP. In other embodiments, the dental device 101 may be formed using a 2-shot injection process, with a first shot for the hard plastic material, and the second shot for the elastomeric material. In certain embodiments, one or both of the elastomeric material and the hard plastic material may be substantially colorless and transparent. In certain embodiments, one or both of the elastomeric material and the hard plastic material may include a coloration, and such a coloration may be used as an indicator for size, hardness/softness, and/or applications for which the dental device 101 is intended by the manufacturer.

Each of the clip elements 105 are formed to hold the dental device 101 in the mouth by clipping onto at least one tooth of the wearer. The plastic from which the clip elements 105 are formed helps enable at least one tooth to be secured in each clip element 105. As shown in FIG. 2, each clip element 105 includes a first side wall 121 and a second side wall 123, with a bottom wall 125 extending between the first and second side walls 121, 123. As shown, the first side wall 121 is coupled to and extends from the facial wall 111, and the bottom wall 125 is coupled to and extends from the biting surface wall 113. In certain embodiments, the each clip element 105 and the arcuate tray member 103 may be integrally formed as a single-component structure. One suitable forming method of such an integral structure is injection molding. Of course, in certain other embodiments, other forming techniques may be utilized. In other embodiments, each clip element 105 may be coupled to the arcuate tray member 103 following manufacture of each individual part.

The first side wall 121 of each clip element 105 serves as a continuation of the facial wall 111, and thus is positioned on the facial side of the teeth 131 when the dental device 101 is worn. Similarly, the bottom wall 125 of each clip element 105 serves as a continuation of the biting surface wall 113, and thus is positioned adjacent the biting surface of teeth 131 when the dental device 101 is worn. The second side wall 123 includes a first wall portion 127 and a second wall portion 129. The first wall portion 127 is coupled to and extends away from the bottom wall 125, toward the first side wall 121, at an acute angle 01. The second wall portion 129 is coupled to and extends away from the first wall portion 127, away from the first side wall 121, at an obtuse angle θ2.

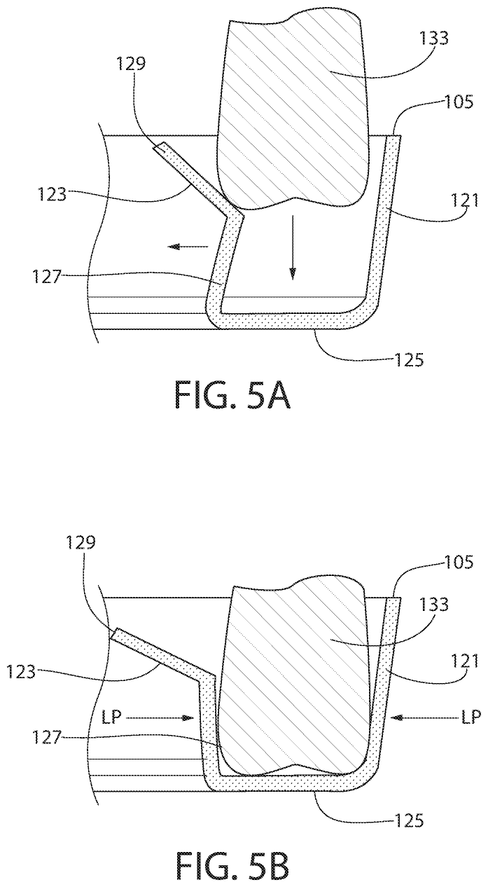

The functioning of the clip elements 105 is graphically illustrated in FIGS. 5A-B. The second side wall 123 is resilient and biased toward the position shown in FIG. 5A. During use, when a tooth is inserted into the clip element 105, the second side wall 123 deflects toward the position shown in FIG. 5B. The second wall portion 129, being angled away from the first side wall 121, serves to provide an opening for the clip element 105 to receive a tooth 133. When receiving a tooth 133, the tooth 133 bears against the second wall portion 129 and pushes the second side wall 123 in a direction away from the first side wall 121, flexing the first wall portion 127, at which point the tooth 133 may be inserted into the clip element 105 as shown in FIG. 5B. When the tooth 133 is inserted into the clip element, the first wall portion 127 remains flexed, so that a lateral pressure LP is applied against the tooth 133 by both of the first and second side walls 121, 123.

The non-customized dental device 101 of FIG. 1 may have a variety of uses, including for the application of gels or other compounds to perform teeth whitening, treat teeth sensitivity, and apply fluoride treatments. In certain embodiments, the dental device 101 may be pre-loaded with the treatment gel, compound, or chemicals.

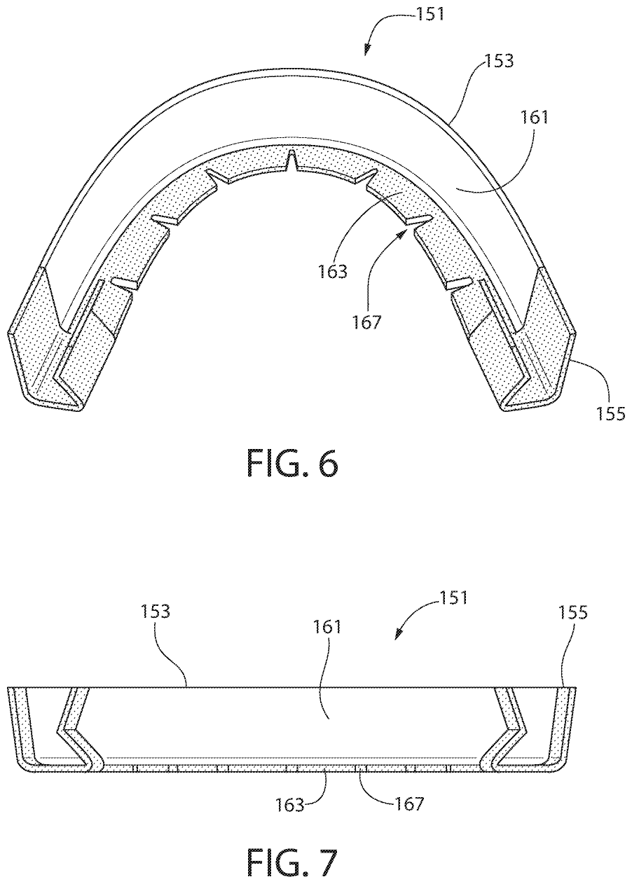

Referring to, FIGS. 6-7 a dental device 151 is illustrated in accordance with another embodiment of the present invention. The dental device 151 includes an L-shaped arcuate tray member 153 with clip elements 155 extending from the ends thereof. The arcuate tray member 153 includes a facial wall 161 and a biting surface wall 163. The clip elements 155 may be formed in the same manner shown in connection with the dental device 101 of FIG. 1. Of course, the clip elements 155 may have any other configuration consistent with the disclosure herein, without limitation except as may be expressly stated in the claims.

In the embodiment of the dental device 151 shown, the facial wall 161 is formed from a first material having a first hardness, and biting surface wall 163 and the clip elements 155 are formed from a second material having a second hardness, with the second hardness being greater than the first hardness. In certain embodiments, the facial wall 161 may be formed from a suitable elastomeric material, and biting surface wall 163 and the clip elements 155 may be formed from a suitable plastic. In certain other embodiments, the biting surface wall 163 and the clip elements 155 may be formed from different materials, with both having a hardness that is greater than the hardness of the material from with the facial wall 161 is formed.

The plastic material of the biting surface wall 163 helps to preserve the overall shape of the dental device 151 when it is being worn, and it helps the dental device 151 to have a better fit to the wearer. The biting surface wall 163 serves as a spring element to both allow the arc of the dental device 151 to expand and contract, and to also return the arc of the dental device 151 to its original shape when no longer being worn. The biting surface wall 163 also includes a plurality of notches 167 which enable the arch of the biting surface wall 163 to expand and contract without causing significant deformation. Expansion or contraction of the arcuate tray member 153 enables the non-customized dental device 151 to better fit the dental arch of a wider group of users. In the embodiment of FIG. 6, the biting surface wall includes seven notches 167, which provide the arcuate tray member 153 with a fair amount of flexibility when the arcuate shape expands or contracts. Of course, more or fewer of the notches 167 may be included in the biting surface wall 163.

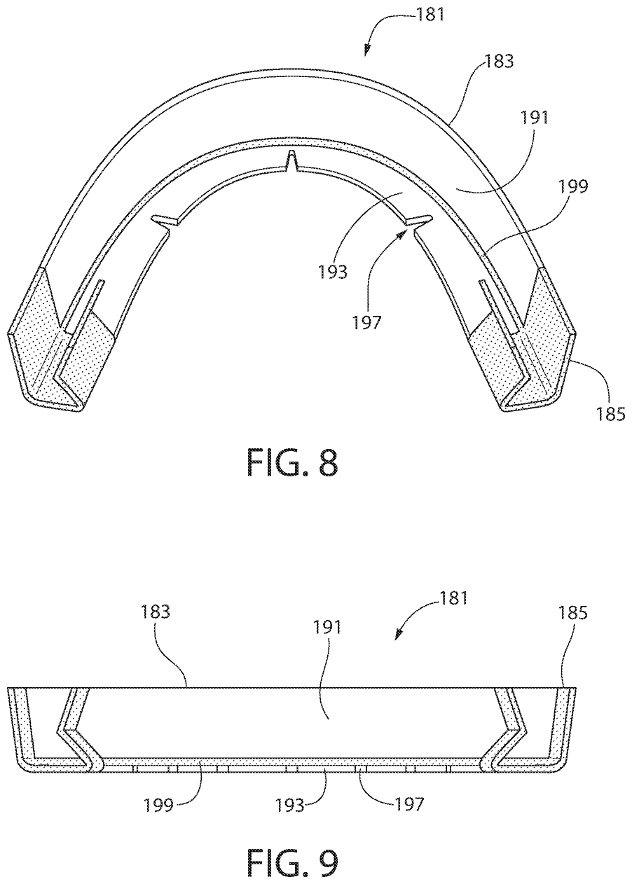

Referring to, FIGS. 8-9 a dental device 181 is illustrated in accordance with another embodiment of the present invention. The dental device 181 includes an L-shaped arcuate tray member 183 with clip elements 185 extending from the ends thereof. The arcuate tray member 183 includes a facial wall 191 and a biting surface wall 193 that are coupled together at a junction 199 formed at the angle of the “L” shape. The clip elements 185 may be formed in the same manner shown in connection with the dental device 101 of FIG. 1. Of course, the clip elements 185 may have any other configuration consistent with the disclosure herein, without limitation except as may be expressly stated in the claims.

In the embodiment of the dental device 181 shown, the facial wall 191 and the biting surface wall 193 are formed from a first material having a first hardness, and junction 199 and the clip elements 185 are formed from a second material having a second hardness, with the second hardness being greater than the first hardness. In certain embodiments, the facial wall 191 and the biting surface wall 193 may be formed from a suitable elastomeric material, and the junction 199 and the clip elements 185 may be formed from a suitable hard plastic. In certain other embodiments, the junction 199 and the clip elements 185 may be formed from different materials, with both having a hardness that is greater than the hardness of the material from with the facial wall 193 and the biting surface wall 195 are formed.

The hard plastic of the junction 199 helps to preserve the overall shape of the dental device 181 when it is being worn, and it helps the dental device 181 to have a better fit to the wearer. The junction 199 serves as a spring element to both allow the arc of the dental device 181 to expand and contract, and to also return the arc of the dental device 181 to its original shape when no longer being worn. The biting surface wall 193 also includes a plurality of notches 197 which enable the arch of the biting surface wall 193 to expand and contract without causing significant deformation. Expansion or contraction of the arcuate tray member 183 enables the non-customized dental device 181 to better fit the dental arches of a wider group of potential users.

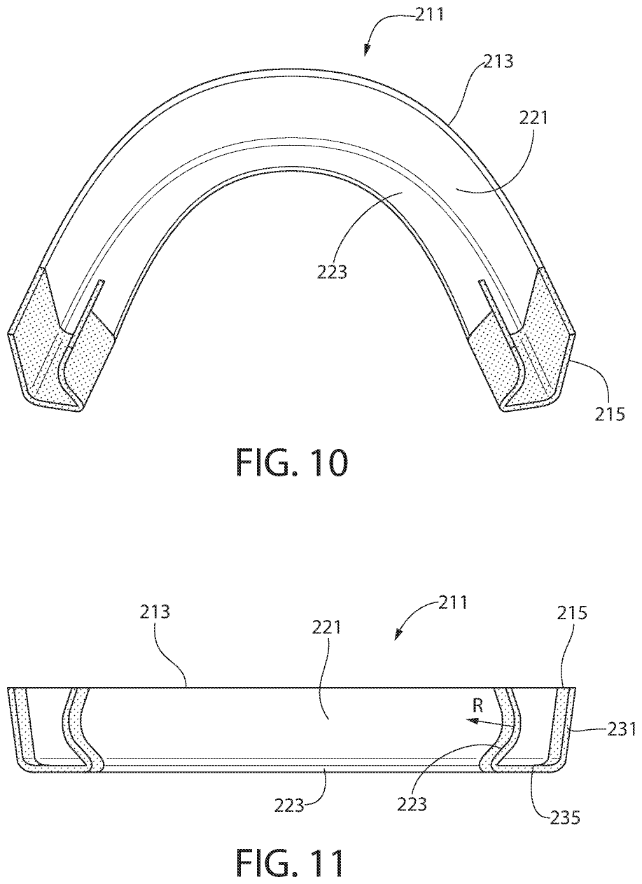

Referring to, FIGS. 10-11 a dental device 211 is illustrated in accordance with another embodiment of the present invention. The dental device 211 includes an L-shaped arcuate tray member 213 with clip elements 215 extending from the ends thereof. The arcuate tray member 213 includes a facial wall 221 and a biting surface wall 223. The clip elements 215 may be formed in the same manner shown in connection with the dental device 101 of FIG. 1. Of course, the clip elements 215 may have any other configuration consistent with the disclosure herein, without limitation except as may be expressly stated in the claims.

In the embodiment of the dental device 211 shown, the facial wall 221 and the biting surface wall 223 are formed from a first material having a first hardness, and the clip elements 185 are formed from a second material having a second hardness, with the second hardness being greater than the first hardness. In certain embodiments, the facial wall 221 and the biting surface wall 223 may be formed from a suitable elastomeric material, and the clip elements 215 may be formed from a suitable hard plastic.

As shown in FIG. 2, each clip element 215 includes a first side wall 231 and a second side wall 233, with a bottom wall 235 extending between the first and second side walls 231, 233. As shown, the first side wall 231 is coupled to and extends from the facial wall 221, and the bottom wall 235 is coupled to and extends from the biting surface wall 223. In certain embodiments, the each clip element 215 and the arcuate tray member 213 may be integrally formed single-component structure. In other embodiments, each clip element 215 may be coupled to the arcuate tray member 213 following manufacture of each individual part.

The first side wall 231 of each clip element 105 serves as a continuation of the facial wall 221, and thus is positioned on the facial side of the teeth when the dental device 211 is worn. Similarly, the bottom wall 235 of each clip element 215 serves as a continuation of the biting surface wall 223, and thus is positioned adjacent the biting surface of teeth when the dental device 211 is worn. The second side wall 233 is formed as an arcuate wall which, as it extends away from the bottom wall 235, curves in an arc first toward and then away from the first side wall 231. Thus, the radius of the second side wall 233 extends away from the first side wall 231. This clip element is able to receive a tooth in a similar manner as described above and shown in FIGS. 5A-B.

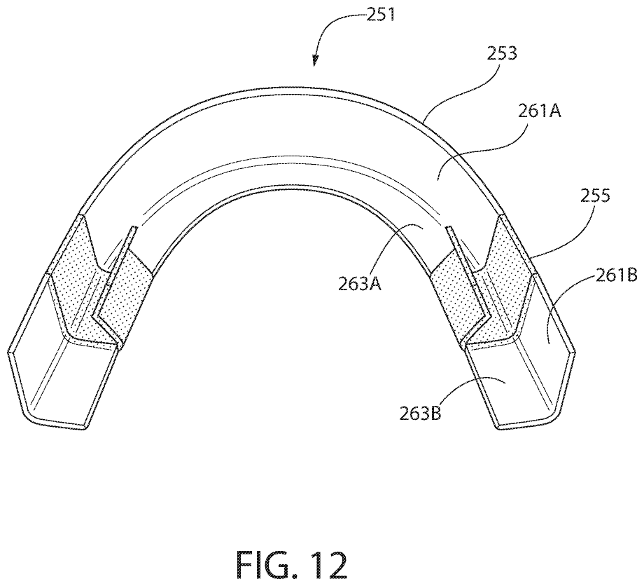

A dental device 251 is illustrated in FIG. 12 in accordance with another embodiment of the present invention. The dental device 251 includes an L-shaped arcuate tray member 253 with clip elements 255 positioned within the arch of the arcuate tray member 253. The arcuate tray member 253 includes a first facial wall section 261A and a second facial wall section 261B, along with a first biting surface wall section 263A and a second biting surface wall section 263B. The clip elements 255 are positioned between the first facial wall section 261A and the first biting surface wall section 263A, on the one side, and the second facial wall section 261B and the second biting surface wall section 263A, on the other side. The clip elements 255 may be formed in the same manner shown in connection with the dental device 101 of FIG. 1. Of course, the clip elements 255 may have any other configuration consistent with the disclosure herein, without limitation except as may be expressly stated in the claims.

In the embodiment of the dental device 251 shown, the arcuate tray member 253 is formed from a first material having a first hardness, and the clip elements 255 are formed from a second material having a second hardness, with the second hardness being greater than the first hardness. In certain embodiments, the arcuate tray member 253 may be formed from a suitable elastomeric material, and the clip elements 255 may be formed from a suitable hard plastic.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A dental device comprising:
a facial wall configured to conform to a facial dental arch of a wearer, the facial wall having a first end and a second end;
a first clip element coupled to and extending from the first end, the first clip element configured to apply a first lateral pressure on a first tooth of the wearer when the first tooth is inserted into the first clip; and
a second clip element coupled to and extending from the second end, the second clip element configured to apply a second lateral pressure on a second tooth of the wearer when the second tooth is inserted into the second clip;
wherein the front wall is formed of a first material having a first hardness, and each clip element is formed of a second material having a second hardness, the second hardness being greater than the first hardness.

2. The dental device of claim 1, wherein each clip element comprises a first side wall opposite a second side wall and a bottom wall extending between the first and second side walls, wherein the first and second side walls apply the lateral pressure.

3. The dental device of claim 2, wherein the first side wall of each clip element is coupled to and extends from the facial wall, and the second side wall of each clip element comprises a first wall portion coupled to and extending away from the bottom wall at an acute angle toward the first side wall and a second wall portion coupled to and extending away from the first wall portion.

4. The dental device of claim 3, wherein the second wall portion of each clip element extends away from the first wall portion at an obtuse angle.

5. The dental device of claim 2, wherein the first side wall of each clip element is coupled to and extends from the facial wall, and the second side wall of each clip element forms an arcuate wall coupled to and extending away from the bottom wall, such that a radius of the arcuate wall extends away from the first side wall.

6. The dental device of claim 1, further comprising a biting surface wall coupled to and extending laterally inward from a bottom edge of the facial wall.

7. The dental device of claim 6, wherein the biting surface wall is formed of the second material.

8. (canceled)

9. (canceled)

10. The dental device of claim 1, further comprising a spring wire extending between the clip elements, the spring wire having an arcuate shape.

11. The dental device of claim 1, wherein the first material is an elastomeric material, and the second material is a plastic material.

12. The dental device of claim 1, wherein the first material and the second material form a chemical bond with each other during an injection molding process.

13. A dental device comprising:
an arcuate tray member configured to conform to a dental arch of a wearer, the arcuate tray member having a first lateral side and a second lateral side;
a first clip element incorporated into the first lateral side, the first clip element configured to apply a first lateral pressure on a first tooth of the wearer when the first tooth is inserted into the first clip;
a second clip element incorporated into the second lateral side, the second clip element configured to apply a second lateral pressure on a second tooth of the wearer when the second tooth is inserted into the second clip;
wherein the arcuate tray member is at least partially formed of a first material having a first hardness, and each clip element is formed of a second material having a second hardness, the second hardness being greater than the first hardness.

14. The dental device of claim 13, wherein:
the first lateral side has a first end, the first clip member coupled to and extending from the first end; and
the second lateral side has a second end, the second clip member coupled to and extending from the second end.

15. (canceled)

16. The dental device of claim 13, wherein each clip element comprises a first side wall opposite a second side wall and a bottom wall extending between the first and second side walls, wherein the first and second side walls apply the lateral pressure.

17. The dental device of claim 16, wherein the first side wall and bottom wall of each clip element are coupled to and extend from the arcuate tray member, and the second side wall of each clip element comprises a first wall portion coupled to and extending away from the bottom wall at an acute angle toward the first side wall and a second wall portion coupled to and extending away from the first wall portion.

18. The dental device of claim 17, wherein the second wall portion of each clip element extends away from the first wall portion at an obtuse angle.

19. The dental device of claim 16, wherein the first side wall and bottom wall of each clip element are coupled to and extend from the arcuate tray member, and the second side wall of each clip element forms an arcuate wall coupled to and extending away from the bottom wall, such that a radius of the arcuate wall extends away from the first side wall.

20. The dental device of claim 13, wherein the arcuate tray member comprises a facial wall and a biting surface wall, with the facial wall formed of the first material and the biting surface wall formed of the second material.

21. (canceled)

22. (canceled)

23. The dental device of claim 13, further comprising a spring wire extending between the clip elements, the spring wire having an arcuate shape.

24. The dental device of claim 13, wherein the first material is an elastomeric material, and the second material is a plastic material.

25. The dental device of claim 13, wherein the first material and the second material form a chemical bond with each other during an injection molding process.
